(19) United States
(12) Patent Application Publication
(10) Pub. No.: US 2025/0221335 A1
(43) Pub. Date: Jul. 10, 2025

(54) BRUSH CUTTER WITH REVERSIBLE BLADE ROTATION

(71) Applicant: Glacier Attachments, LLC, Carson City, MI (US)

(72) Inventor: Erik Kapteyn, Carson City, MI (US)

(73) Assignee: Glacier Attachments, LLC, Carson City, MI (US)

(21) Appl. No.: 18/593,219

(22) Filed: Mar. 1, 2024

Related U.S. Application Data
(60) Provisional application No. 63/619,101, filed on Jan. 9, 2024.

(51) Int. Cl. A01D 34/80; A01D 34/64; A01D 34/74; A01D 34/82

(52) U.S. Cl. CPC A01D 34/80; A01D 34/64; A01D 34/82; A01D 34/74

(57) ABSTRACT

A brush cutter includes a hydraulic system that rotates a cutting blade. The hydraulic system is configured to permit a rotational direction of the cutting blade to be reversed. The cutting blade may include opposite edges having serrated and non-serrated cutting edges, whereby the rotational direction of the blade or blades can be reversed to cut different types of vegetation.

### CROSS-REFERENCE TO RELATED APPLICATION

This application claims the benefit under 35 U.S.C. § 119(e) to U.S. Provisional Patent Application No. 63/619,101, filed Jan. 9, 2024, entitled “BRUSH CUTTER WITH REVERSIBLE BLADE ROTATION,” which is incorporated herein by reference in its entirety.

### BACKGROUND OF THE INVENTION

Various types of attachments for skid steers, tractors, and other such vehicles have been developed. The attachments may include moving parts (e.g. blades) that may be operably interconnected with a hydraulic system of the vehicle to provide powered operation of the attachment.

### BRIEF SUMMARY OF THE INVENTION

An aspect of the present disclosure is a brush cutter including a support structure that is configured to permit the brush cutter to be attached to a vehicle having a hydraulic system. The brush cutter further includes a hydraulic motor attached to the support structure. The hydraulic motor includes first and second ports that are configured to be fluidly coupled to a hydraulic system of a vehicle whereby a shaft of the hydraulic motor rotates in a first direction when pressurized hydraulic fluid is supplied to the first port, and the shaft rotates in a second direction that is opposite to the first direction when pressurized hydraulic fluid is supplied to the second port. The brush cutter includes a rotating blade assembly that is operably connected to the shaft of the hydraulic motor. The blade assembly includes a blade having a first cutting edge that is configured to cut when the rotating blade assembly rotates in a first cutting direction. The blade further includes a second cutting edge that is configured to cut when the rotating blade assembly rotates in a second cutting direction that is opposite to the first cutting direction. The first cutting edge is serrated and the second cutting edge is not serrated. The brush cutter further includes first and second hydraulic lines having first ends fluidly coupled to the first and second ports of the hydraulic motor. The first and second hydraulic lines have second ends that are configured to be fluidly coupled to first and second parts of a hydraulic system of the vehicle to provide hydraulic power to rotate the hydraulic motor. The brush cutter further includes a check valve that is fluidly coupled to the first and second hydraulic lines in an orientation in which the check valve permits flow of hydraulic fluid between the first and second hydraulic lines in a first direction, and restricts flow of hydraulic fluid between the first and second hydraulic lines in a second direction. The brush cutter further includes quick-disconnect hydraulic connectors fluidly coupled to the first and second hydraulic lines. The quick-disconnect hydraulic connectors can be disconnected and reconnected to: 1) change which one of the first and second hydraulic lines is fluidly coupled to the first port of the hydraulic motor and change which one of the first and second hydraulic lines is fluidly coupled to the second port of the hydraulic motor to thereby change a direction of rotation of the shaft of the hydraulic motor without changing a flow direction of hydraulic fluid from first and second ports of a hydraulic system of a vehicle, and/or: 2) reverse an orientation of the check valve relative to the first and second hydraulic lines whereby the check valve permits flow of hydraulic fluid between the first and second hydraulic line in a second direction and restricts flow of hydraulic fluid between the first and second hydraulic lines in a first direction to permit a direction of rotation of the shaft of the hydraulic motor to be reversed when a flow direction of hydraulic fluid from first and second ports of a hydraulic system of a vehicle is reversed.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a perspective view of a vehicle including a brush cutter according to a first aspect of the present disclosure;

FIG. 2 is a perspective view of a brush cutter according to an aspect of the present disclosure showing a cover of the brush cutter in an open position;

FIG. 3 is a perspective view of the brush cutter of FIG. 2 showing the cover of the brush cutter in a closed position;

FIG. 4 is a partially fragmentary perspective view of a brush cutter according to an aspect of the present disclosure;

FIG. 5 is a schematic showing a brush cutter according to an aspect of the present disclosure;

FIG. 6 is a schematic of a vehicle and brush cutter according to an aspect of the present disclosure showing the blade assembly rotating in a first direction;

FIG. 7 is a schematic of the vehicle and brush cutter of FIG. 6 showing the blade assembly rotating in a second direction;

FIG. 8 is a schematic of a vehicle and brush cutter according to another aspect of the present disclosure showing a blade assembly rotating in a first direction;

FIG. 9 is a schematic of the vehicle and brush cutter of FIG. 8 showing the blade assembly rotating in a second direction;

FIG. 10 is a partially fragmentary perspective view of the blade;

FIG. 11 is a partially fragmentary perspective view of the blade;

FIG. 12 is a partially fragmentary top plan view of the blade;

FIG. 13 is a partially fragmentary bottom plan view of the blade;

FIG. 14 is a partially fragmentary front view of the blade;

FIG. 15 is a partially fragmentary rear view of the blade;

FIG. 16 is a first side view of the blade; and

FIG. 17 is a second side view of the blade.

### DETAILED DESCRIPTION

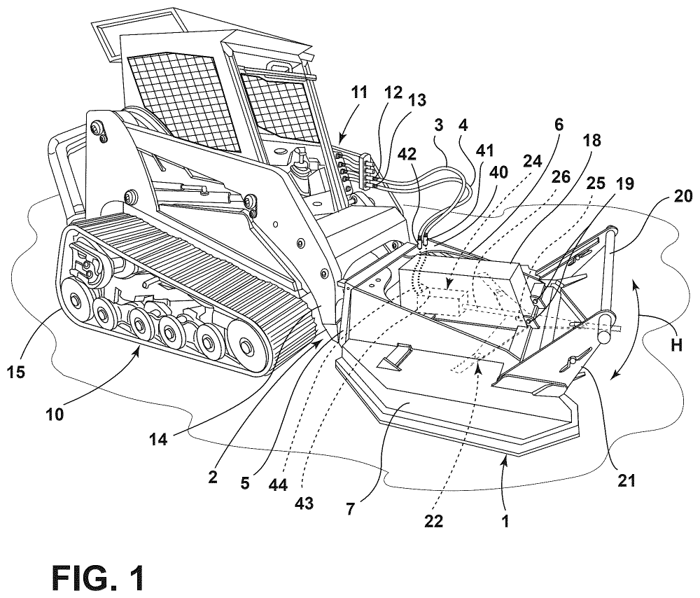

For purposes of description herein the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood by one having ordinary skill in the art that construction of the described device and other components is not limited to any specific material. The device and other components disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) (e.g. hydraulic) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the device may be varied, the nature or number of adjustment positions provided between the elements may be varied. It should be noted that the elements and/or assemblies of the device may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present disclosure.

It will be understood that any described processes or steps within described processes may be combined with other disclosed processes or steps to form structures within the scope of the present device. The exemplary structures and processes disclosed herein are for illustrative purposes and are not to be construed as limiting.

With reference to FIG. 1, a brush cutter 1 according to an aspect of the present disclosure may be attached to a vehicle 10 at an interface 2. Vehicle 10 may include an engine (not shown) of a known type that powers a hydraulic system 11 whereby hydraulic lines 3 and 4 can be utilized to fluidly couple brush cutter 1 to the hydraulic system 11 of vehicle 10 at hydraulic couplers 12 and 13. As discussed below, vehicle 10 may have a user input such as a switch that permits an operator to select which of the lines 3 and 4 is pressurized whereby the other of lines 3 and 4 functions as a low pressure return line. Vehicle 10 may include a movable assembly 14 that can be used to raise and lower brush cutter 1 as shown by the arrow “H.” Vehicle 10 may also include tracks 15, wheels, or the like provided the vehicle 10 can be moved during operation. Vehicle 10 may comprise a skid steer, tractor, or other powered vehicle having a hydraulic system 11 whereby brush cutter 1 can be attached to vehicle 10 at an interface 2.

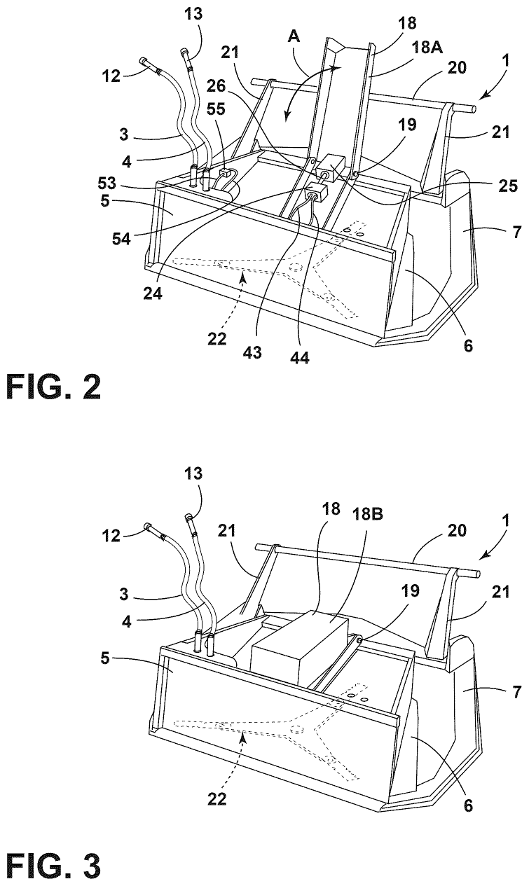

Brush cutter 1 includes a support structure 6 comprising attachment structure 5 and housing 7 (See also FIGS. 2 and 3). Attachment structure 5 may be configured to attach brush cutter 1 to various types of vehicles 10 having manual and/or quick coupling connectors having known configurations. Support structure 6 includes a bar 20 that is supported by arms 21. A cover 18 may be pivotably connected to the support structure 6 by hinges 19 whereby the cover 18 can be moved between an open position 18A (FIG. 2) and a closed position 18B (FIG. 3). Cover 18 may remain closed due to gravity or it may be secured in closed position 18B utilizing a latch, screws, or other suitable arrangement (not shown). When the cover 18 is in an open position (FIG. 2) the cover may rest against bar 20.

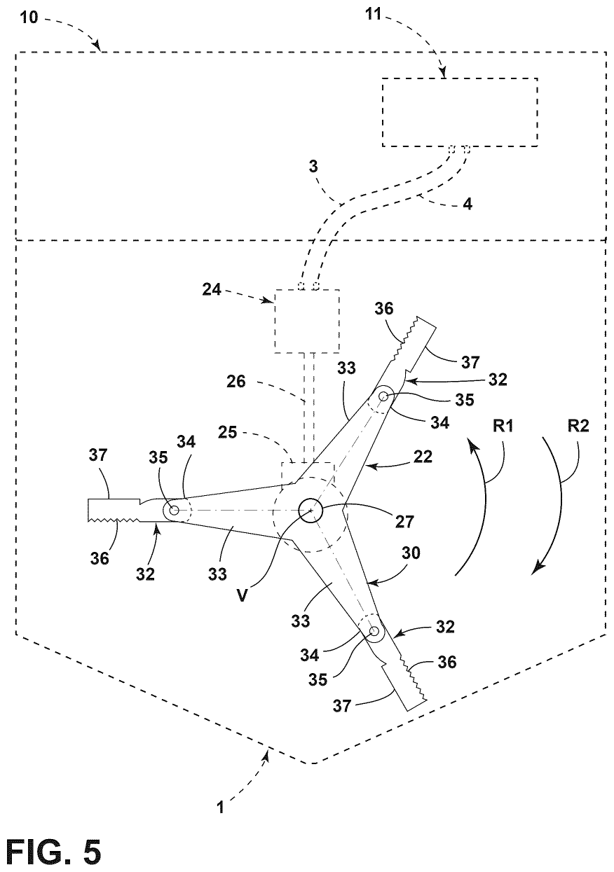

Cover 18 can be opened (FIG. 2) to provide access to a hydraulic motor 24, 90° gear box 25 and shaft 26 interconnecting hydraulic motor 24 and gear box 25 (see also FIG. 5). In the illustrated example, blade assembly 22 is secured to a vertical shaft 27 (FIG. 5) whereby the blade assembly 22 rotates about a vertical axis “V.” It will be understood, however, that various hydraulic drive arrangements may be utilized, and the present disclosure is not limited to any specific configuration such as the 90° gear box 25 described herein.

With reference to FIG. 5, blade assembly 22 may include a blade carrier structure 30 that is attached to vertical shaft 27 whereby the structure 30 rotates with vertical shaft 27. One or more cutting blades 32 may be pivotably attached to arms 33 of structure 30 by pivotable connectors such as pins 35 adjacent ends 34 of arms 33. In the illustrated example, blade assembly 22 includes three blades 32. However, the blade assembly 22 may include only a single blade 32, a pair of blades 32, three blades 32, or four or more blades 32. It will be understood that the blade carrier structure 30 may be configured as required to support the number of cutting blades 32 that are utilized in a particular application. As discussed in more detail below, each cutting blade 32 may include a serrated edge 36 and a non-serrated opposite edge 37, and the rotational direction of blade assembly 22 can be switched (reversed) between rotating directions “R1” and “R2.” Although serrated edge 36 and non-serrated edge 37 may be utilized to cut a wide range of vegetation, brush, and the like, non-serrated edge 37 may comprise a sharpened (e.g. beveled) straight edge that is suitable for cutting grass and other smaller vegetation, whereas serrated edge 36 may be configured to cut brush, trunks of trees, or other thicker vegetation.

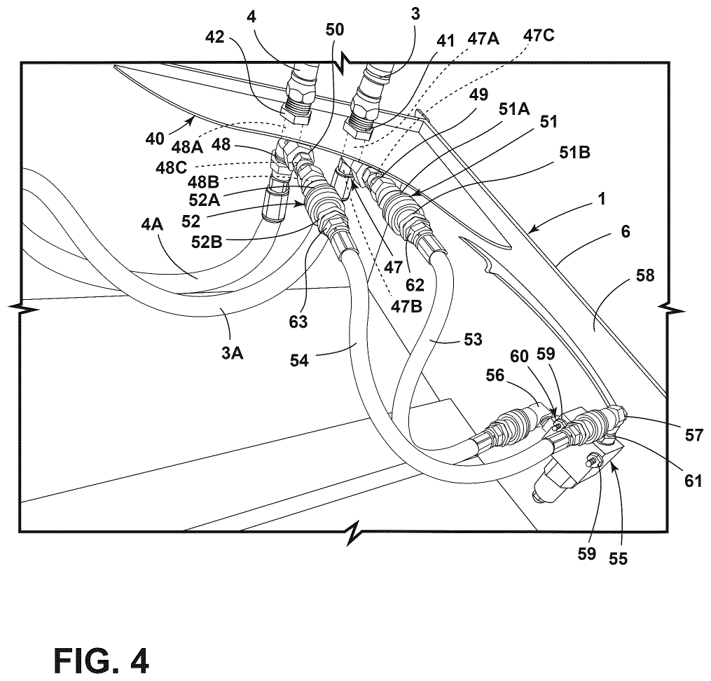

Referring again to FIG. 4, hydraulic lines 3 and 4 may be secured to a plate 40 of support structure 6 by fittings 41 and 42, respectively. Hydraulic line 3 is fluidly coupled to a hydraulic line 3A, and hydraulic line 4 is fluidly coupled to hydraulic line 4A. Hydraulic lines 3A and 4A are fluidly coupled to hydraulic motor 24 of brush cutter 1. A T-fitting 47 includes ports 47A, 47B that fluidly interconnect hydraulic lines 3 and 3A. T-fitting 47 also includes a transverse portion 49 having a port 47C that is fluidly coupled to the hydraulic lines 3 and 3A by ports 47A, 47B. Similarly, hydraulic line 4 is fluidly coupled to hydraulic line 4A by T-fitting 48 having ports 48A, 48B and a transverse portion 50 having a port 48C that is fluidly coupled to hydraulic lines 4 and 4A. End 49 (port 47C) of T-fitting 47 is fluidly coupled to a hydraulic line 53 by a hydraulic quick coupler 51, and end 50 (port 48C) of T-fitting 48 is fluidly coupled to a hydraulic line 48 by a hydraulic quick coupler 52. Hydraulic line 53 is fluidly coupled to a port 60 of a check valve 55 by a fitting 56, and hydraulic line 54 is fluidly coupled to a port 61 of check valve 55 by a fitting 57. It will be understood that lines 3 and 3A are normally at the same hydraulic pressure and may be referred to as first and second portions of a first hydraulic line. Similarly, 4 and 4A may be considered to be first and second portions of a second line.

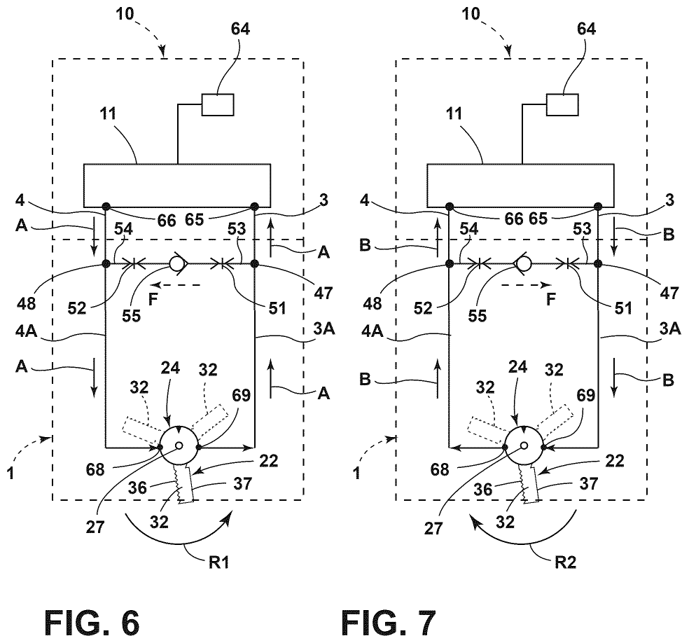

As discussed in more detail below in connection with FIGS. 6 and 7, check valve 55 permits fluid flow in one direction, and inhibits (prevents) fluid flow in an opposite direction to prevent damage if the hydraulic system 11 is turned off while blade assembly 22 is rotating. For example, if line 4 is pressurized and line 3 is functioning as a return line, the check valve 55 may be oriented to prevent flow of hydraulic fluid from hydraulic line 54 to hydraulic line 53. If the hydraulic system 11 of vehicle 10 is turned off while the blade assembly 22 is rotating, the rotating mass will tend to pressurize the hydraulic line 43 and line 53. However, because the check valve 55 only prevents flow in one direction, the pressurized hydraulic fluid from line 53 will pass through the check valve 55 and flow through hydraulic line 54 and into hydraulic line 44 whereby the hydraulic fluid is returned to the motor 24. If check valve 55 were not fluidly coupled to the hydraulic lines 43 and 44, a sudden shut off of hydraulic system 11 would cause high pressure in the return lines, which could damage the components.

As discussed in more detail below in connection with FIGS. 6 and 7, quick couplers 51 and 52 permit ends 62 and 63 of hydraulic lines 53 and 54, respectively, to be switched between hydraulic lines 3 and 4 to reverse the orientation of check valve 55 relative to hydraulic lines 3 and 4. Quick couplers 51 and 52 may have substantially identical construction, with first halves or components 51A and 52A that couple to second halves or components 51B and 52B, respectively. Quick couplers 51 and 52 may comprise commercially available quick couplers of a known type having first and second parts that can be disconnected and connected, preferably without requiring the use of tools. First components 51A and 52A may (optionally) comprise a female half or plug (e.g. threadless) and second components 51B and 52B may (optionally) comprise a male half or plug (e.g. threadless). Alternatively, ports 51A and 52A may be male components, and ports 51B and 52B may be female parts. Quick couplers 51 and 52 may comprise, for example, sleeve retraction (“Pioneer”) quick couplers (e.g. with ball or poppet valve) or flat face quick couplers. Quick couplers 51 and 52 preferably do not require use of a wrench to connect and/or disconnect parts 51A, 51B and 52A, 52B. It will be understood that various types of hydraulic quick couplers are known in the art, and the present disclosure is not limited to a specific quick coupler type or design. This permits hydraulic flow from the hydraulic system 11 of vehicle 10 to be reversed, thereby rotating the blade assembly 22 in an opposite direction. It will be understood that quick couplers 51 and 52 could be located at the other ends of lines 53 and 54, check valve 55, or at central portions of lines 53 and 54.

With further reference to FIG. 6, hydraulic system 11 includes ports 65 and 66 that are fluidly connected to the hydraulic lines 3 and 4 of brush cutter 1. Hydraulic system 11 may be operably connected to a user input such as a switch 64 that permits an operator to select which port 65 and 66 receives high pressure hydraulic fluid, whereby the other of ports 65 and 66 receives return hydraulic fluid. In FIG. 6, the hydraulic system 11 is set (configured) to provide high pressure hydraulic fluid to port 66, and receives hydraulic fluid at port 65. As shown by the arrows “A,” pressurized hydraulic fluid from port 66 flows through hydraulic lines 4 and 4A and enters port 68 of hydraulic motor 24. The hydraulic fluid then exits port 69 of hydraulic motor 24 and returns to port 65 of hydraulic system 11 through lines 3 and 3A. In FIG. 6, check valve 55 is oriented such that fluid flow is only permitted in the direction of the arrow “F.” Thus, high pressure hydraulic fluid in lines 4 and 4A at T-fitting 48 cannot flow through check valve 55 in a direction opposite to the arrow F such that hydraulic fluid in line 4 flows through T-fitting 48 into line 4A. This results in the cutting blade assembly rotating in a first rotational direction R1. In the illustrated example, rotation in the direction R1 permits serrated edges 36 of blades 32 to cut. However, it will be understood that the serrated edge 36 and non-serrated edge 37 may have an orientation whereby non-serrated edge 37 cuts when blade assembly 22 is rotated in the direction R1. Also, although first rotation direction R1 is counterclockwise in FIG. 6, the first rotational direction could be clockwise.

If the hydraulic system 11 is turned off when operating in the configuration of FIG. 6, hydraulic motor 24 will tend to generate increased pressure at port 69 and at T-fitting 47 due to the rotating mass. This will cause hydraulic fluid to flow through check valve 55 in the direction of the arrow F, and the hydraulic fluid will then be returned to port 66 of hydraulic motor 24. If the switch 64 were to be switched such that port 65 of hydraulic system 11 is the high pressure port, and port 66 is a return port, the high pressure at T-fitting 47 will cause fluid to flow through check valve 55, and the hydraulic fluid will return to port 66 of hydraulic system 11 without providing power to motor 24. Thus, when the check valve 55 is oriented as shown in FIG. 6, changing the position of switch 64 will not result in powered rotation of blade assembly 22 in a direction opposite R1.

To reverse rotation of blade assembly from R1 (FIG. 6) to an opposite direction R2 (FIG. 7), the quick couplers 51 and 52 can be disconnected from the configuration of FIG. 6, and the check valve 55 may be reconnected in the orientation shown in FIG. 7. This can be accomplished by disconnecting coupler port 51A (FIG. 4) from port 51B, disconnecting port 52A from port 52B, connecting part 51A to part 52B, and connecting port 52A to port 51B. The switch 64 may then be actuated by a user whereby port 66 of hydraulic system 11 provides high pressure hydraulic fluid to port 65. The hydraulic fluid then flows in the direction of the arrows “B” whereby port 69 of hydraulic motor 24 is pressurized, and hydraulic fluid exits port 66 of hydraulic motor 24. This causes blade assembly 22 to rotate in a direction “R2” which is opposite to the rotation direction R1 of FIG. 6. Because the orientation of check valve 55 in FIG. 7 is opposite to the orientation of FIG. 6, T-fitting 47 is pressurized, and hydraulic fluid cannot flow through check valve 55 when high pressure hydraulic fluid is present in lines 3 and 3A. If the switch 64 is switched to pressurize port 66 when the check valve 55 is in the orientation of FIG. 7, T-fitting 48 will be pressurized, and the hydraulic fluid will flow through check valve 55 in the direction of the arrow F and return to port 65 of hydraulic system 11 without providing powered rotation of blade assembly 22.

Because the quick couplers 51 and 52 permit rapid changes between the orientations of FIGS. 6 and 7, the rotational direction of the blade assembly 22 can be quickly switched between the rotational directions R1 and R2 by switching the switch 64, thereby permitting a user to selectively use either serrated edge 36 or non-serrated edge 37. For example, if a vehicle 10 is being utilized to clear land using brush cutter 1, some areas may be primarily grass or other smaller vegetation, and a user may rotate the blade assembly 22 to utilize the non-serrated edge 37 while cutting the grass. However, if a user encounters an area with brush or other larger vegetation, the user can turn off the vehicle 10, switch the orientation of the check valve 55 as required between the orientations of FIGS. 6 and 7. The switch 64 can then be actuated to reverse the rotational direction of blade assembly 22, thereby allowing the user to cut brush or other vegetation utilizing the serrated edges 36 as required. Thus, brush cutter 1 permits a user to quickly reverse the orientation of the check valve 55 and reverse rotation of blade assembly 22 to permit use of opposite cutting edges to adapt the brush cutter 1 as required based on the conditions at a job site.

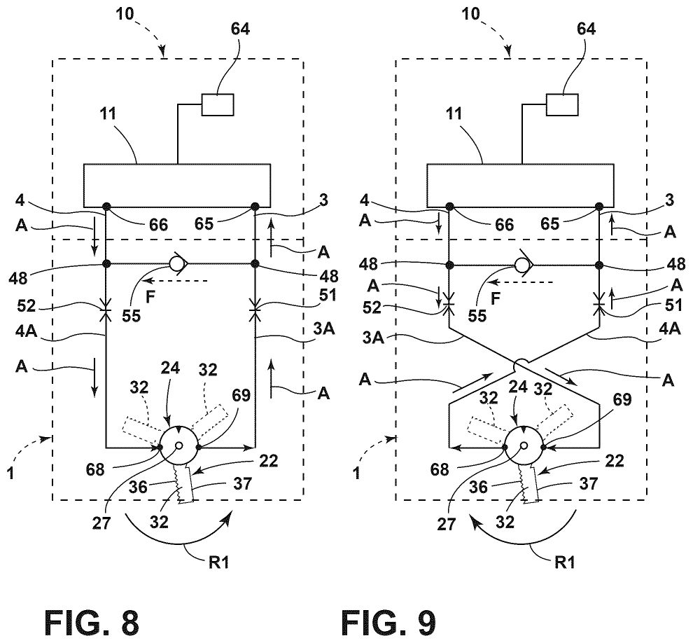

With further reference to FIGS. 8 and 9, the hydraulic system may also be configured such that quick couplers 51 and 52 are positioned between T-fittings 47 and 48 and ports 68 and 69 of hydraulic motor 24. When brush cutter 1 is configured as shown in FIGS. 8 and 9, high pressure hydraulic fluid may be supplied to port 66 of hydraulic system 11, and port 65 may act as a return port, whereby hydraulic fluid flows in the direction of the arrows A as shown in FIGS. 8 and 9. To reverse the rotational direction of blade assembly 22 from the direction R1 (FIG. 8) to the direction R2 (FIG. 9), the quick couplers 51 and 52 may be utilized to switch the connections of lines 3A and 4A whereby pressurized fluid flows through line 4 into line 3A to port 69 of hydraulic motor 24 as shown in FIG. 9, whereby hydraulic fluid exits port 68 of motor 24 and flows through line 4A into line 3 and into port 65 of hydraulic system 11. Thus, switching between the configurations of FIGS. 8 and 9 reverses the rotational direction of the blade assembly 22 (without actuating switch 64 to reverse hydraulic system 11). When brush cutter 1 is configured as shown in FIGS. 8 and 9, the check valve 55 retains the same orientation relative to the ports 65 and 66 of hydraulic system 11, whereby the check valve 55 only permits flow of fluid in the direction of arrow F. Thus, if hydraulic system 11 is turned off, the rotation of blade assembly 22 will tend to pressurize T-fitting 47, and check valve 54 will allow flow of hydraulic fluid in the direction of the arrow F to prevent damage to the hydraulic system. If switch 64 is actuated, hydraulic fluid will flow from port 65 through line 3, through check valve 55, and back to port 66 through line 4. The brush cutter of FIGS. 8 and 9 permits a user to quickly and easily reverse the rotation direction of blade assembly 22 between the rotation directions R1 and R2 whereby serrated edge 36 or non-serrated edge 37 of blades 32 can be utilized. As noted above, the switch 64 does not need to be actuated to change between rotational directions R1 and R2 when brush cutter 1 is configured as shown in FIGS. 8 and 9.

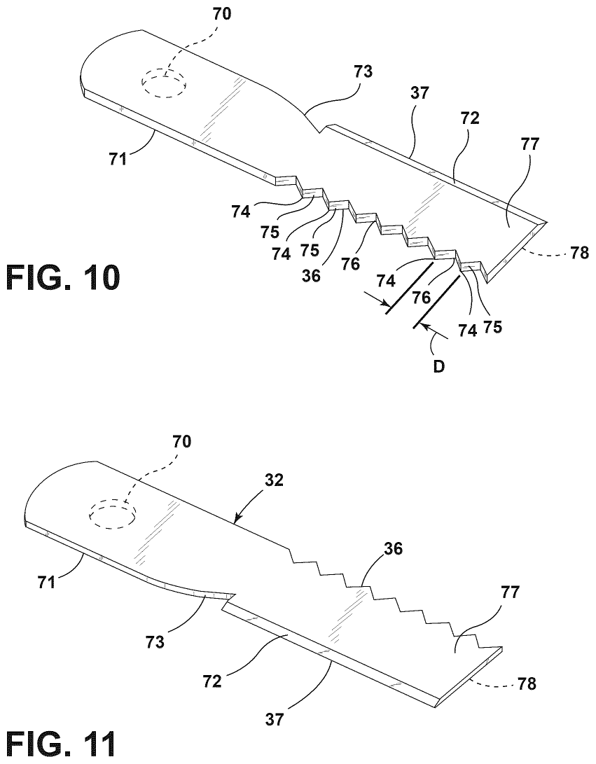

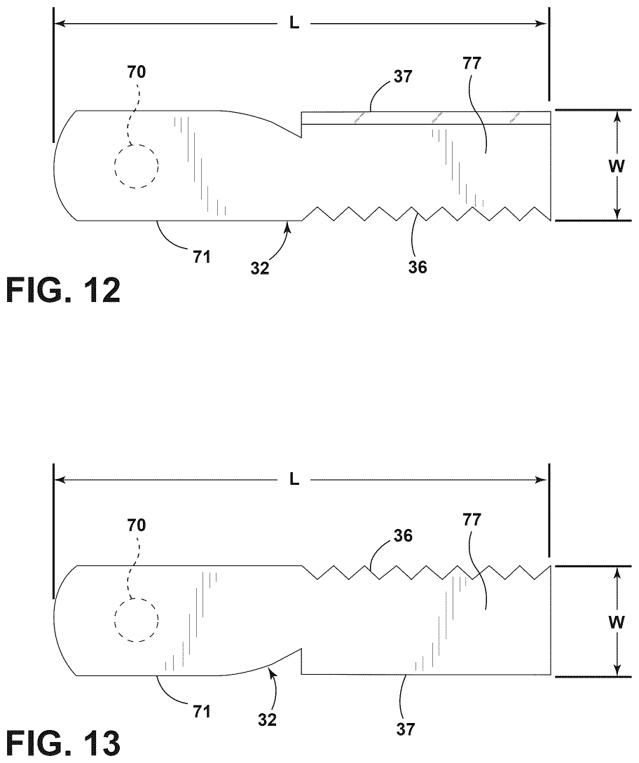

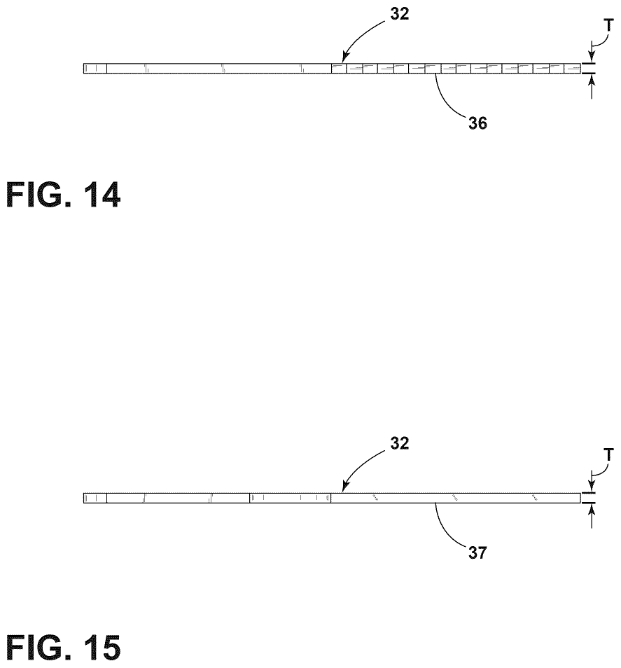

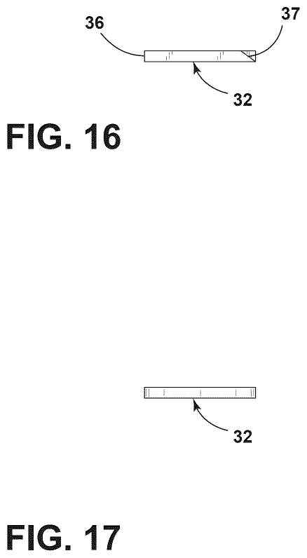

With further reference to FIGS. 10-17, cutting blade 32 may include an opening 70 adjacent an end 71. The opening 70 is configured to receive a pin 35 or other suitable connector as described above in connection with FIG. 5. Blade 32 may have an overall length L of about 12″-36″, and a width W of about 2″-6″. However, virtually any suitable length L and width W may be utilized as required for a particular size brush cutter or other application. Thus, the blades 32 may have the lengths and widths that are less than the ranges noted above, or greater than the ranges noted above. The thickness T (FIGS. 14 and 15) may be about 0.10″ to about 0.50″ as required for a particular application. However, the thickness may be greater than or less than the ranges noted above. Also, although the blade 32 may have a uniform thickness, blade 32 may also have a non-uniform thickness.

Non-serrated edge 37 of cutting blade 32 may include at least one bevel 72 (FIGS. 10 and 11), and the blade 32 may optionally be configured such that the beveled (angled) surface 72 faces upwardly during operation. Blade 32 may optionally include a recessed or notched region 73 adjacent to non-serrated edge 37 to facilitate sharpening of non-serrated edge 37. Non-serrated edge 37 may be substantially linear or straight as shown in FIGS. 10 and 11. Alternatively, the non-serrated edge 37 may have an irregular (non-linear) shape (e.g. curved) as required for a particular application. In general, edges 36 and 37 may have virtually any suitable configuration, and edges 36 and 37 may be identical or substantially similar. For example, if edges 36 and 37 are both straight or serrated, a user can cut with a first one of edges 36 and 37 until it becomes dull, then switch rotation and cut with the other of edges 36 and 37 until both edges are dull.

With reference to FIG. 10, serrated edge 36 may include a plurality of angled surfaces 75 that extend between upper and lower surfaces 77 and 78 of blade 32. Angled surfaces 75 may be orthogonal to upper and lower surfaces 77 and 78, or the angled surfaces 75 may extend at a non-orthogonal angle relative to surfaces 77 and 78. Angled surfaces 75 form a plurality of points 74 and bases 76. The points 74 may be spaced apart a distance “D.” In general, the distance D may be any size as required for a particular application. In general, the distance D may be about 0.10″-1.0″. However, the distance D may be larger or smaller than this range. Also, the serrations of serrated edge 36 may have substantially uniform sizes and shapes as shown in FIGS. 10 and 11, or the serrations formed by surfaces 75 may have different sizes and shapes as required for a particular application. Also, the opposite edges 36 and 37 may both be straight, or both may be serrated. For example, the opposite edges 36 and 37 may have serrations that have different sizes and/or configurations to cut different types of vegetation or brush. Alternatively, the opposite edges 36 and 37 may both be non-serrated, and one of the opposite edges may be curved or otherwise configured differently than the other opposite edge to facilitate cutting specific types of vegetation or the like. Still further, the opposite edges 36 and 37 may both be serrated, or both may be straight, and the rotational direction of the blade assembly 22 may be reversed when one of the edges 36 or 37 becomes dull to thereby permit a blade 32 to be utilized longer between sharpening.

It is to be understood that variations and modifications can be made on the aforementioned structure without departing from the concepts of the present invention, and further it is to be understood that such concepts are intended to be covered by the following claims unless these claims by their language expressly state otherwise.

1. A brush cutter comprising:
a support structure;
a hydraulic motor having first and second ports whereby a shaft of the hydraulic motor rotates in a first direction when pressurized hydraulic fluid is supplied to the first port, and the shaft rotates in a second direction that is opposite to the first direction when pressurized hydraulic fluid is supplied to the second port;
a rotating blade assembly operably connected to the shaft of the hydraulic motor, the blade assembly including at least one blade having a first cutting edge that is configured to cut when the rotating blade assembly rotates in a first cutting direction, and a second cutting edge that is configured to cut when the rotating blade assembly rotates in a second cutting direction that is opposite the first cutting direction, wherein the first cutting edge is serrated and the second cutting edge is not serrated;
first and second hydraulic lines fluidly coupled to the first and second ports of the hydraulic motor, respectively, wherein the first and second hydraulic lines are configured to be fluidly coupled to first and second ports of a hydraulic system of a vehicle to provide hydraulic power to rotate the hydraulic motor;
a check valve fluidly coupled to the first and second hydraulic lines whereby the check valve permits flow of hydraulic fluid between the first and second hydraulic lines in a first direction, and restricts flow of hydraulic fluid between the first and second hydraulic lines in a second direction that is opposite to the first direction;
first and second quick hydraulic couplers fluidly coupled to the first and second hydraulic lines, wherein each quick hydraulic coupler has first and second ports that can be disconnected and reconnected to:
1) reverse an orientation of the check valve relative to the first and second hydraulic lines whereby the check valve permits flow of hydraulic fluid between the first and second hydraulic lines in the second direction and restricts flow of hydraulic fluid between the first and second hydraulic lines in the first direction to permit changing a direction of rotation of the shaft of the hydraulic motor when a flow direction of hydraulic fluid from first and second parts of a hydraulic system of a vehicle is reversed; and/or:
2) change which one of the first and second hydraulic lines is fluidly coupled to the first port of the hydraulic motor and change which one of the first and second hydraulic lines is fluidly coupled to the second port of the hydraulic motor to change a direction of rotation of the shaft of the hydraulic motor without changing a flow direction of hydraulic fluid from first and second ports of a hydraulic system of a vehicle.

2. The brush cutter of claim 1, including:
a third hydraulic line having a first end fluidly coupled to a first port of the check valve, and a second end that is detachably connected to the first hydraulic line by the first quick hydraulic coupler;
a fourth hydraulic line having a first end fluidly coupled to a second port of the check valve, and a second end that is detachably connected to the second hydraulic line by the second hydraulic coupler;
whereby the second ends of the third and fourth hydraulic lines can be disconnected from the first and second hydraulic lines, respectively and connected to the other of the first and second hydraulic lines, respectively, to thereby reverse the orientation of the check valve relative to the first and second hydraulic lines.

3. The brush cutter of claim 2, wherein:
each quick hydraulic coupler includes releasably interconnected first and second parts;
the first hydraulic line includes first and second portions that are fluidly coupled to first and second ports, respectively, of a first fitting, the first fitting having a third port that is fluidly coupled to the first port of the first quick coupler, and wherein the second port of the first quick coupler is connected to the second end of the third hydraulic line; and
the second hydraulic line includes first and second portions that are fluidly coupled to first and second ports, respectively of a second fitting, the second fitting having a third port that is fluidly coupled to the first port of the second quick coupler, and wherein the second port of the second quick coupler is connected to the second end of the fourth hydraulic line.

4. The brush cutter of claim 3, wherein:
the first and second fittings comprise T-fittings.

5. The brush cutter of claim 2, wherein:
the check valve is mounted to the support.

6. The brush cutter of claim 1, wherein:
the first hydraulic line includes first and second portions that are fluidly coupled by the first quick hydraulic coupler;
the second hydraulic line includes first and second portions that are fluidly coupled by the second quick hydraulic coupler; and:
the first and second quick couplers can be disconnected and reconnected whereby the second portion of the first hydraulic line can be fluidly coupled to the first portion of the second hydraulic line, and the second portion of the second hydraulic line can be fluidly connected to the first portion of the first hydraulic line to thereby change a direction of rotation of the shaft of the hydraulic motor without changing a flow direction of hydraulic fluid of a hydraulic system of a motor vehicle.

7. The brush cutter of claim 6, wherein:
the first portions of the first and second hydraulic lines are configured to be fluidly coupled to a hydraulic system of a vehicle.

8. The brush cutter of claim 7, wherein:
the check valve is fluidly coupled to the first portions of the first and second hydraulic lines by first and second T-fittings.

9. The brush cutter of claim 1, wherein:
the second cutting edge of the blade is straight.

10. The brush cutter of claim 9, wherein:
the rotating blade assembly includes a blade holding structure operably connected to the shaft of the hydraulic motor, and at least three blades pivotably coupled to the blade holding structure.

11. A vehicle including the brush cutter of claim 1.

12. A vehicle comprising:
a vehicle structure;
a hydraulic pump;
a brush cutter connected to the vehicle structure, the brush cutter including:
a support structure;
a hydraulic motor having a rotatable output shaft;
at least one blade operably connected to the rotatable output shaft, the at least one blade having first and second opposite cutting edges that are configured to cut when the output shaft is rotated in first and second opposite directions, respectively, wherein the first cutting edge has a first shape that is configured to cut brush and the second cutting edge has a second cutting edge having a second shape that is configured to cut grass, wherein the first and second shapes are not identical;
first and second hydraulic lines fluidly coupling the hydraulic motor to the hydraulic pump;
a check valve fluidly coupled to the first and second hydraulic lines by quick couplers; and wherein:
the vehicle includes a user-operable selector that permits a user to cause the hydraulic pump to switch between supplying pressurized hydraulic fluid to the first hydraulic line and the second hydraulic line whereby a user can select first or second rotation directions by causing the output shaft of the hydraulic motor to rotate in the first direction to cut with the first cutting edge of the at least one blade, or in the second direction to cut with the second cutting edge of the least one blade, and wherein an orientation of the check valve can be switched between first and second orientations by disconnecting and reconnecting the quick couplers to prevent flow of pressurized hydraulic fluid between the first and second hydraulic lines as required to provide powered rotation of the output shaft in the first or second direction selected by a user.

13. The vehicle of claim 12, wherein:
the first cutting edge is serrated;
the second cutting edge is straight.

14. The vehicle of claim 12, wherein:
the brush cutter includes at least one blade holding structure operably connected to the shaft of the hydraulic motor;
the at least one blade comprises at least three blades pivotably coupled to the blade holding structure.

15. The vehicle of claim 12, wherein:
each quick hydraulic coupler includes releasably interconnected first and second parts;
the first hydraulic line includes first and second portions that are fluidly coupled to first and second ports, respectively, of a first fitting, the first fitting having a third port that is fluidly coupled to the first port of the first quick coupler, and wherein the second port of the first quick coupler is connected to the second end of the third hydraulic line; and
the second hydraulic line includes first and second portions that are fluidly coupled to first and second ports, respectively of a second fitting, the second fitting having a third port that is fluidly coupled to the first port of the second quick coupler, and wherein the second port of the second quick coupler is connected to the second end of the fourth hydraulic line.

16. The vehicle of claim 15, wherein:
the first and second fittings comprise T-fittings.

17. The vehicle of claim 12, wherein:
the check valve is mounted to the support structure.

18. A method of cutting vegetation and brush at a job site using a vehicle having a brush cutter that is operably connected to a hydraulic system of the vehicle, the method comprising:
providing a brush cutter having a rotating blade assembly with a plurality of blades having serrated edges that cut when the blade assembly is rotated in a first direction, and straight edges that cut when the blade assembly is rotated in a second direction, the brush cutter including a hydraulic motor that is fluidly coupled to first and second hydraulic lines, and a check valve fluidly coupled to the first and second hydraulic lines;
causing the blade assembly to rotate a selected one of the first and second directions while cutting a selected one of brush and grass, respectively at the job site;
disconnecting and reconnecting the quick couplers at the job site to switch an orientation of the check valve relative to the first and second hydraulic lines at the job site;
switching the hydraulic system of the vehicle to cause the blade assembly to rotate in the other of the first and second directions while cutting the other of brush and grass at the job site.

19. The method of claim 18, wherein:
the quick couplers are disconnected and reconnected with the use of tools.

20. The method of claim 19, wherein:
each quick coupler includes a first port that detachably connects to a second port, whereby the first port of each quick coupler can be connected to the second port of either quick coupler.
